(19) United States
(12) Patent Application Publication
(10) Pub. No.: US 2011/0185759 A1
(43) Pub. Date: Aug. 4, 2011

(54) WATER FUNNEL AND ICE MAKER FOR REFRIGERATOR HAVING THE SAME

(76) Inventors: Byeong-Gyu Kang, Gyeongsangnam-do (KR); Jae-Youl Lee, Gyeongsangnam-Do (KR); Jeong-Youl Lee, Gyeongsangnam-do (KR)

(21) Appl. No.: 12/921,010

(22) PCT Filed: Dec. 31, 2008
(86) PCT No.: PCT/KR08/07899

§ 371 Date: Sep. 3, 2010

(30) Foreign Application Priority Data
Mar. 7, 2008 (KR) 10-2008-0021637

(51) Int. Cl. F25C 1/24; B67C 11/00

(52) U.S. Cl. 62/340; 141/331

(57) ABSTRACT

A water funnel and an ice maker for a refrigerator, the water funnel including a water collecting portion having a discharge hole through which water is collected and discharged; and a drain tube having a path therein, the path downwardly extending to be communicated with the discharge hole and having a uniform cross section or a cross section increasing toward a lower side thereof, whereby a blockage of the path is prevented and thusly water is smoothly supplied to the tray.

### TECHNICAL FIELD

The present invention relates to a water funnel and an ice maker for a refrigerator having the same, and more particularly, to a water funnel capable of preventing a blockage of a path and an ice maker for a refrigerator having the same.

### BACKGROUND ART

In general, a refrigerator stores foods such as meat, fish, vegetables, fruits, drinks, and the like in a fresh condition. A refrigerator includes a refrigerator main body having cooling chambers such as a freezing chamber, a refrigerating chamber, a vegetable compartment, etc., doors for opening and closing the cooling chambers, and a refrigeration cycle device for supplying cooling air to the cooling chambers.

The refrigeration cycle device is generally implemented as a vapor compression refrigeration cycle which is comprised of a compressor for compressing a refrigerant, a condenser for radiating the compressed refrigerant, an expansion unit for expanding the refrigerant, and an evaporator in which the refrigerant absorbs latent heat and thus to be evaporated.

In the refrigerator, the refrigeration cycle device operates when the temperature of the freezing chamber or the refrigerating chamber is higher than a preset temperature. As the refrigeration cycle device operates, an evaporator generates cooling air. Then, the cooling air generated by the evaporator is circulated in the freezing chamber and refrigerating chamber by a cooling fan.

While the cooling air is circulated in the freezing chamber and the refrigerating chamber, the freezing chamber, the refrigerating chamber and a vegetable compartment provided in the refrigerating chamber can be maintained at the preset temperature.

Refrigerators may be categorized into various types according to the circulation method of cooling air, location of a freezing chamber and a refrigerating chamber, and the structure of the evaporator.

Meanwhile, the refrigerator may be equipped with a variety of functions so as to enhance a user's convenience and satisfaction.

For instance, the refrigerator includes an ice making system (or apparatus) for making ice cubes (ice pieces).

The ice making system may consist of an ice maker for making ice cubes, and an ice bank disposed below the ice maker for storing the ice cubes made by the ice maker.

The ice maker is comprised of an ice tray having a plurality of cells so as to make ice cubes in a certain shape, and a frame for supporting the ice tray.

The ice tray may be disposed inside the frame so as to be spaced from each other in up and down directions. A water funnel may be provided above the ice tray so as to supply water to the ice tray.

The water funnel may include a water collecting portion disposed at an upper portion thereof and having a cylindrical or rectangular shape, and a pipe-shaped guiding unit communicated to a lower portion of the water collecting portion so as to guide water to a lower side.

A water supply unit (water tank) may supply water to the water funnel and the ice tray.

In the process for making ice by supplying water to the water funnel, ice pieces may be generated in the water supply unit and/or the water funnel (more specifically, the water collecting portion).

However, in the related art ice maker for a refrigerator, since the guiding unit of the water funnel is formed to have a pipe diameter (cross section) reducing toward a lower side thereof, ice introduced through an inlet having a relatively large cross section cannot be discharged from an outlet having a smaller cross section, thereby causing a blockage of a path.

In addition, when a blockage occurs at the outlet of the guiding unit, a water supply time is extended.

In addition, when a blockage occurs at the outlet of the guiding unit, water drops to an outside of the ice tray by overflowing a sidewall of the water collecting portion, instead of being supplied to the ice tray, and then is frozen inside the frame.

In addition, if water is not smoothly supplied to the ice tray since the outlet of the guiding unit is blocked, ice cannot be smoothly discharged, and the guiding unit and/or the water collecting portion may be frozen.

### DISCLOSURE OF INVENTION

### Technical Problem

Therefore, it is an object of the present invention to provide a water funnel capable of smoothly supplying water by preventing a blockage of a path, and an ice maker for a refrigerator having the same.

It is another object of the present invention to provide a water funnel capable of preventing a blockage of a path by introduced ice pieces since the ice pieces introduced into the path are smoothly discharged, and an ice maker for a refrigerator having the same.

It is another object of the present invention to provide a water funnel capable of preventing an overflow of the water due to a blockage of a path by preventing a blockage of a path inlet, and an ice maker for a refrigerator having the same.

### Technical Solution

To achieve these objects, there is provided a water funnel, including: a water collecting portion having a discharge hole through which water is collected and discharged; and a drain tube having a path therein, the path downwardly extending from the water collecting portion to be communicated with the discharge hole and having a uniform cross section or a cross section increasing toward a lower side thereof.

Here, the discharge hole is formed to have an oval shape.

The discharge hole is disposed at a bottom portion of the water collecting portion in an eccentric state to one side thereof.

The discharge hole is configured such that a major axis thereof is disposed in an eccentric direction.

The water collecting portion has a rectangular shape, and the discharge hole is configured such that a major axis thereof is disposed in a lengthwise direction of the water collecting portion.

The path of the drain tube is formed to have an oval cross section so as to correspond to that of the discharge hole.

The water collecting portion includes a guiding unit disposed along the major axis direction of the discharge hole.

The guiding unit is implemented as a guiding groove concavely formed at a bottom portion of the water collecting portion.

The guiding unit is implemented as a plurality of guiding ribs protruding from a bottom surface of the water collecting portion and disposed parallel to each other.

The water collecting portion includes a discharge groove concavely formed to be communicated with the discharge hole.

The drain tube is formed inclined toward a center of the water collecting portion.

A tapered portion having a tapered cross section is formed at the lower end of the drain tube.

The tapered portion includes a guiding protrusion protruding in a lengthwise direction.

To achieve these objects, there is provided an ice maker for a refrigerator, including:

a frame; a tray disposed inside the frame; and a water funnel disposed above the tray so as to guide ice-making water to the tray.

Here, the tray is detachably supported by the frame.

The frame has an opened area at one side thereof, and further comprises a door for opening and closing the opened area of the frame.

The tray is rotatably installed at the frame.

The frame further comprises a lever for rotating the tray.

### Advantageous Effects

As described above, according to the present invention, since the path has the cross section increasing toward its lower end as compared to the discharge hole, the ice pieces introduced into the path through the discharge hole may be rapidly discharged. Thusly, there is no blockage of the path, thereby smoothly supplying water and reducing a time for water supply.

In addition, since the path has the oval-shaped cross section, the ice pieces having a relatively longer length as compared to the path having the circular cross section may also be smoothly discharged. Accordingly, the blockage of the path due to the introduced ice pieces may be prevented.

In addition, since the discharge hole is formed to be communicated with the discharge hole and concavely formed in a narrow width, water may flow through the path via the discharge groove even though the discharge hole is blocked by the ice pieces having a relatively large size as compared to the discharge hole. Accordingly, the overflow of water to the outside of the water collecting portion due to the blockage of the path may be prevented.

In addition, since the guiding unit formed along the major axis direction of the discharge hole is provided at one side of the discharge hole, the ice pieces having a relatively longer length may be introduced into the discharge hole along the major axis direction of the discharge hole. Accordingly, the ice pieces can be smoothly discharged, thus to prevent the blockage of the path due to the ice pieces.

### BRIEF DESCRIPTION OF THE DRAWINGS

In the drawings:

FIG. 1 is an overview showing an ice maker for a refrigerator according to one exemplary embodiment of the present invention;

FIG. 2 is a perspective view showing the ice maker for a refrigerator in FIG. 1;

FIG. 3 is a cross-sectional view showing the ice maker in FIG. 2;

FIG. 4 is a perspective view showing a water funnel in FIG. 3;

FIG. 5 is a cross-sectional view taken along line V-V in FIG. 4;

FIG. 6 is a perspective view showing a water funnel according to another exemplary embodiment of the present invention; and

FIG. 7 is a perspective view showing a water funnel according to still another exemplary embodiment of the present invention.

### MODE FOR THE INVENTION

Description will be given in detail to a water funnel and a refrigerator having the same according to the preferred embodiments of the present invention, examples of which are illustrated in the accompanying drawings.

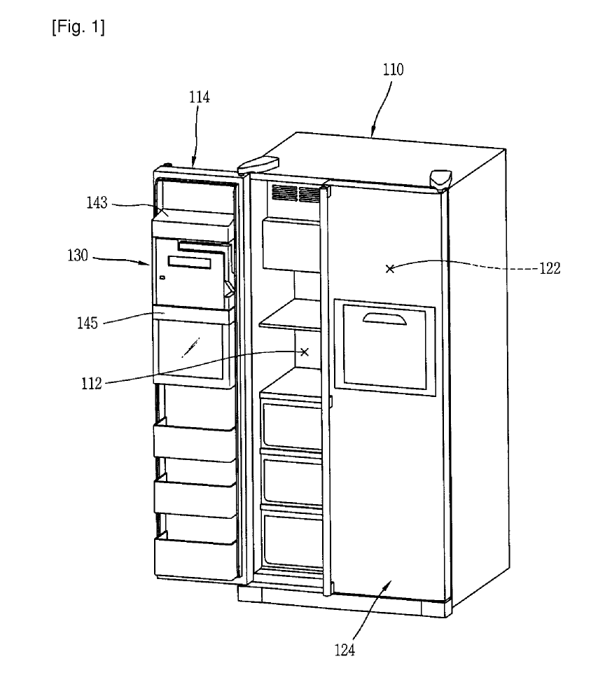

Referring to FIG. 1, the refrigerator includes a refrigerator main body 110 having a freezing chamber 112 and a refrigerating chamber 122 therein, and a freezing chamber door 114 and a refrigerating chamber door 124 hinge-coupled to a front surface of the refrigerator main body 110 so as to open and close the freezing chamber 112 and the refrigerating chamber 122, respectively. An ice maker 130 for a refrigerator according to one embodiment of the present invention may be disposed in one of the freezing chamber door 114 and the refrigerating chamber door 112.

Here, the refrigerator main body may be implemented as a bottom freezer type in which a refrigerating chamber is formed at an upper portion of the refrigerator main body and a freezing chamber is disposed therebelow, and an ice making chamber may be disposed at the refrigerating chamber door. Here, the ice maker 130 for a refrigerator may be installed within the ice making chamber provided at the refrigerating chamber door of the bottom freezer type refrigerator.

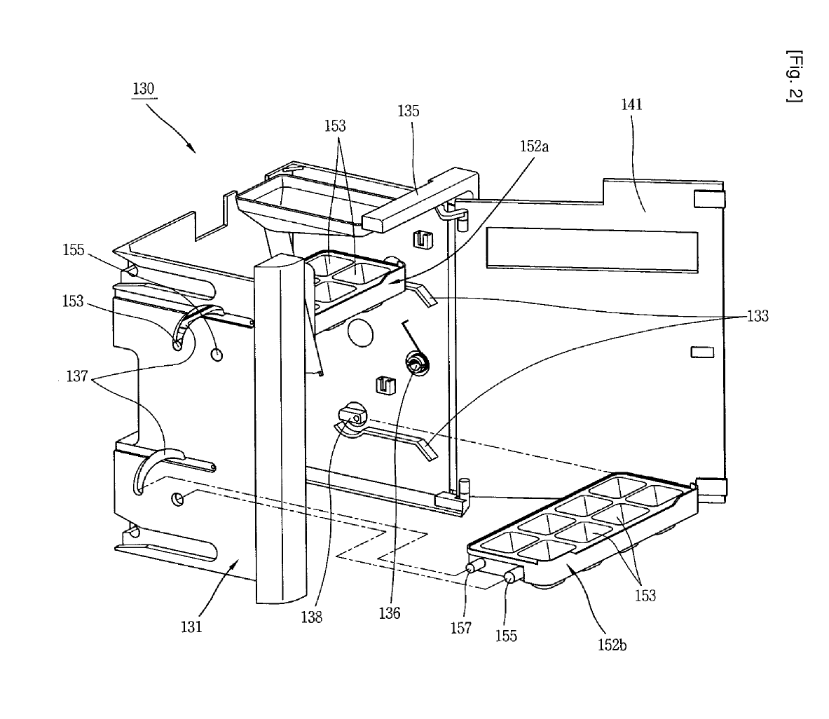

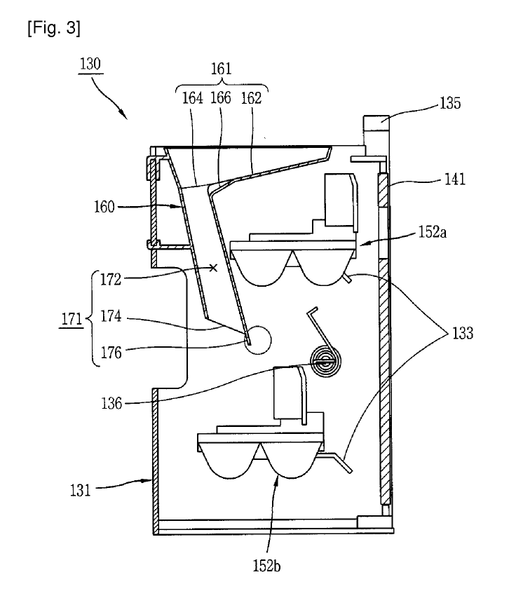

Referring to FIGS. 2 and 3, the ice maker 130 for a refrigerator according to the present invention includes a frame 131 having a receiving space therein, a lower tray 152b disposed inside the frame 131, and a water funnel 160 disposed above the lower tray 152b so as to guide water for making ice to the lower tray 152b and having a path with a uniform cross section or a cross section increasing toward lower side thereof.

The frame 131 is formed to have an approximately rectangular parallelepiped shape, and includes a receiving space having an opened one side, i.e., an opened front surface and an opened upper side thereof. A door 141 for opening and closing the opened area is provided at the opened side of the frame 131. The door 141 is hinge-coupled to the frame 131 so as to be rotatable.

An upper tray 152a and the lower tray 152b are disposed inside the frame 131 so as to be spaced from each other in up and down directions. Tray support units 133 are respectively formed in the inner-side walls of the frame 131 so as to detachably support the upper and lower trays 152a and 152b. This is to separate the upper tray 152a and/or the lower tray 152b from the frame 131, move the trays 152a and 152b to a position where ices are needed, thus to separate the ices from the upper and lower trays 152a and 152b.

The upper and lower trays 152a and 152b are formed to have an approximately rectangular parallelepiped shape. The upper and lower trays 152a and 152b include a plurality of cells 153 therein so as to form a certain shape of ice cubes. By this, ice cubes can be made in correspondence to the shape of the cells 153. The trays 152a and 152b include rotation shafts 155 protruding from both ends of each tray 152a and 152b in a lengthwise direction so as to be rotatable with respect to the frame 131.

Protrusions 157 protrude from each one end surface of the upper and lower trays 152a and 152b so as to be disposed parallel to the rotation shaft 155. Slots 137 for receiving the protrusions 157 therein are formed through the frame 131. The slots 137 are formed to have an arc shape corresponding to a rotation track of the respective protrusions 157.

If the upper tray 152a and the lower tray 152b rotate centering around the rotation shaft 155, the slots 137 contact the respective protrusions 157, thus to control the rotation movement of the respective protrusions 157. With this configuration, one end portions of the trays 152a, 152b having the protrusions 157 rotate less than another end portions thereof. That is, torsion occurs in each tray 152a, 152b by a rotation angle difference between both ends of each tray 152a, 152b. Accordingly, ices formed inside the trays 152a, 152b are separated and dropped from the inner-side walls of the trays 152a, 152b.

A lever 135 is provided at an upper end of the frame 131 so as to provide a driving force for rotating the upper tray 152a and the lower tray 152b at a certain angle. The lever 135 may be rotatably coupled to the frame 131 in up and down directions. A rotation shaft 136 is disposed at a lower end of the lever 135 in a horizontal direction. The rotation shaft 136 of the lever 135 is insertion-coupled to one side of the frame 131 so as to be rotatable.

Tray drive shafts 138 are respectively provided at upper and lower sides of the rotation shaft 136 of the lever 135 so as to rotation-drive the upper tray 152a and the lower tray 152b. The tray drive shafts 138 may be disposed parallel to the rotation shaft 136 of the lever 135. A power transmitting means (not shown) is provided between the rotation shaft 136 of the lever 135 and the tray drive shafts 138 so as to transfer a rotation force of the rotation shaft 136 of the lever 135 to the tray drive shafts 138. The power transmitting means may be implemented as a plurality of gears engaged with each other.

Meanwhile, the water funnel 160 for supplying water to the lower tray 152b is positioned at an inner upper side of the frame 131. Here, a water tank 143 may be disposed at an upper end of the frame 131 so as to supply water to the water funnel 160 and the upper tray 152a. In addition, an ice bank 145 may be provided at a lower end of the frame 131 so as to accommodate ices separated and dropped from the upper and lower trays 152a and 152b.

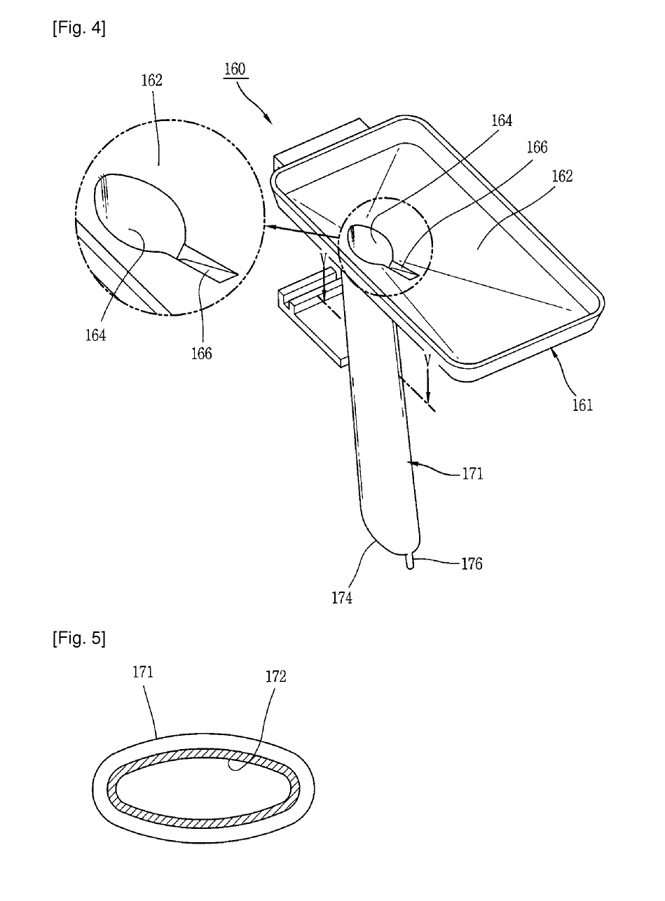

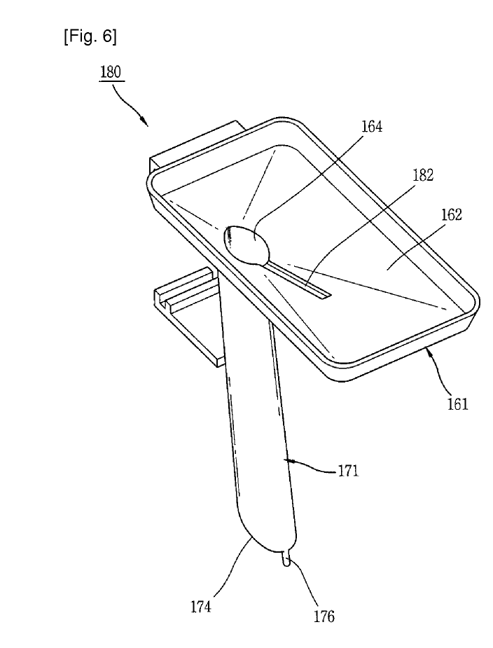

Referring to FIGS. 4 and 5, the water funnel 160 includes a water collecting portion 161 having a discharge hole 164 through which water is collected and discharged, and a drain tube 171 having a path 172 therein, the path 172 downwardly extending to be communicated with the discharge hole 164 and having a cross section increasing toward a lower side thereof. With this configuration, when ice pieces are introduced to the discharge hole 164, the introduced ice pieces may be downwardly move and be discharged, thereby preventing the path 172 from being narrower or blocked by the ice pieces.

The water collecting portion 161 is formed to have a rectangular shape in a planar projection. The discharge hole 164 through which the collected water downwardly flows is penetratingly formed at one side of a bottom surface 162. Here, the water collecting portion 161 may be formed as a variety of shapes (a circle, an oval, a hexagon, etc.). The discharge hole 164 may be eccentrically disposed at one side of the water collecting portion 161 in a lengthwise direction. The bottom surface 162 of the water collecting portion 161 is formed inclined such that water is collected to the discharge hole 164.

The discharge hole 164 and the path 172 may be formed as an oval cross section, whereby ice pieces having a relatively longer length may easily be discharged. Here, the path 172 may be formed such that upper and lower sides thereof have the same pipe diameter.

The discharge hole 164 and the path 172 may be formed such that major axes thereof are disposed in a lengthwise direction of the water collecting portion 161, whereby ice pieces having a long length may be easily introduced into the discharge hole 164.

Meanwhile, the drain tube 171 may be configured such that an upper end thereof is communicated to the discharge hole 164 eccentrically disposed at the bottom portion of the water collecting portion 161, and a lower end thereof is inclined to face a lower central side of the water collecting portion 161. With this configuration, water may smoothly flow along the inner inclination surface of the drain tube 171.

The drain tube 171 may include a protruding tapered portion 174 at a lower end thereof such that the drain tube 171 has a tapered cross section toward the lower end thereof. This is to gradually reduce the size and number of water drops to remain in the drain tube 171 after water is supplied. In addition, the tapered portion 174 may be extended such that a tip thereof is disposed above the central portion of the lower tray 152b in a width direction, thereby reducing a possibility of water being splashed to an outside of the lower tray 152b.

In addition, a guiding protrusion 176 extending from the drain tube 171 in a lengthwise direction may be formed at an end portion of the tapered portion 174. This is to further reduce the size and number of the remaining water drops.

Meanwhile, a discharge recess 166 is downwardly concaved on the bottom surface of the water collecting portion 161 so as to be communicated to the discharge hole 164. A bottom of the discharge groove 166 may have a different inclination angle from the bottom surface 162 of the water collecting portion 161. In addition, the bottom of the discharge groove 166 is formed inclined to the drain tube 171. This is to guide water in the water collecting portion 161 to the drain tube 171 via the discharge groove 166 when large-sized ice pieces block the discharge hole 164. By this configuration, the water supplied to the water collecting portion 161 can be prevented from overflowing the water collecting portion 161. In addition, ice pieces having a thin and long shape can also be smoothly introduced into the discharge hole 164. Here, a plurality of the discharge grooves 166 may be provided, and in this instance, may be spaced from each other along a circumferential direction of the discharge hole 164.

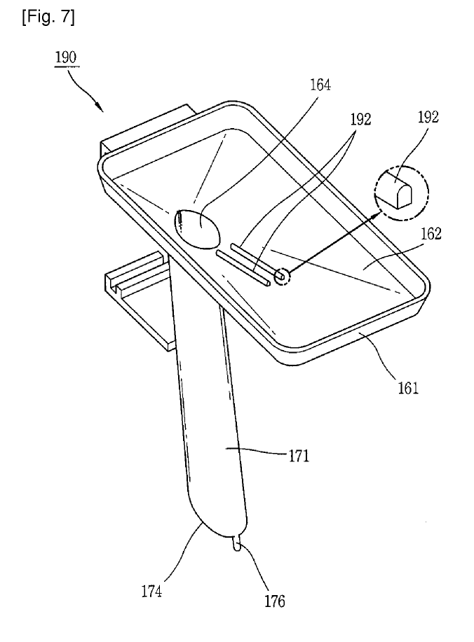

A guiding unit for guiding ices to be arranged along the major axis of the discharge hole 164 may further be provided on the upper surface of the bottom surface 162 of the water collecting portion 161. Description of the guiding unit will be given in more detail with reference to FIGS. 6 and 7. This is to arrange ice pieces having the long and thin shape in a lengthwise direction of the discharge hole 164, and facilitate the introduction and discharge of the ice pieces. By this arrangement, the blockage of the discharge hole 164 due to the length of the ice pieces may be prevented. Even though the path 172 of the drain tube 171 becomes narrower by the freezing of remaining water therein, the ice pieces are introduced in a major axis direction having a relatively large area, thereby preventing the blockage of the path 172.

With such configuration, if a water tank is disposed above the water funnel 160, water is supplied to the water funnel 160 and the upper tray 152a. The water dropped into the water collecting portion 161 of the water funnel 160 is collected by the inclination of the bottom surface 162 and then introduced to the discharge hole 164. Here, the discharge hole 164 and the drain tube 171 are formed to have an oval shape such that ice pieces having a relatively long length may be smoothly introduced and discharged, thereby preventing the blockage of the path. In addition, the path 172 of the drain tube 171 has a uniform cross section or a cross section extending toward the lower side thereof, thereby preventing the blockage of the path by the introduced ice pieces.

The water downwardly flowing along the drain tube 171 is dropped to the lower tray 152b and stored in each cell. Here, the tapered portion 174 and the guiding protrusion 176 serve to reduce the size and amount of the water drops to remain in the drain tube 171 by a surface tension of water after water is supplied, thereby preventing the freezing when making ices.

If a certain period of time has elapsed in a state that the freezing chamber door is closed after the water is dropped onto the upper and lower trays 152a and 152b, the water is frozen and thusly turned into ices. When the ices made inside the trays 152a and 152b are to be separated, the lever 135 is downwardly rotated. Accordingly, the upper tray 152a and the lower tray 152b are rotated in a clockwise direction in the drawing, and the protrusions 157 contact the tip of the respective slots 137. Since the one end portions having the protrusions 157 of the upper and lower trays 152a, 152b rotate less than another end portions thereof, torsion is generated, whereby ices inside the upper and lower trays 152a and 152b are separated and dropped.

FIG. 6 is a perspective view showing a water funnel according to another exemplary embodiment of the present invention. For reference, the same reference numerals will be given to the same or similar components having the same or similar functions, and detailed explanations therefor are omitted.

Referring to FIG. 6, the water funnel 180 includes a water collecting portion 161 having a discharge hole 164 through which water is collected and discharged, and a drain tube 171 having a path 172 therein, the path 172 downwardly extending to be communicated with the discharge hole 164 and having a cross section increasing toward a lower side thereof.

The discharge hole 164 and the path 172 may be formed to have an oval cross section. The discharge hole 164 and the path 172 may be disposed in a lengthwise direction of the water collecting portion 161.

A guiding unit for guiding ices to be introduced by being arranged at one side along the major axis of the discharge hole 164 may further be provided in the water collecting portion 161. The guiding unit is implemented as a guiding groove 182 downwardly concaved from an upper surface of the bottom surface 162 of the water collecting portion 161. Preferably, the guiding groove 182 extends along the major axis direction of the discharge hole 164.

With such configuration, if a water tank 143 is disposed above the water funnel 180, water is supplied to the water funnel 180 and the upper tray 152a. The water dropped to the water collecting portion 161 of the water funnel 180 is collected by the inclination of the bottom surface 162 and then introduced to the discharge hole 164. Here, the guiding groove 182 serves to arrange ice pieces in the major axis direction of the discharge hole 164 so as to be introduced into the discharge hole 164. Accordingly, the ice pieces are smoothly discharged, thereby preventing the blockage of the path 172 by the ice pieces.

Hereinafter, descriptions of still another exemplary embodiment of the present invention are given with reference to FIG. 7.

FIG. 7 is a perspective view showing a water funnel according to still another exemplary embodiment of the present invention. Referring to FIG. 7, the water funnel 190 includes a water collecting portion 161 having a discharge hole 164 through which water is collected and discharged, and a drain tube 171 having a path 172 therein, the path 172 downwardly extending to be communicated with the discharge hole 164 and having a cross section increasing toward a lower side thereof.

A guiding unit for guiding ices to be introduced by being arranged at one side along the major axis of the discharge hole 164 may further be provided in the water collecting portion 161. The guiding unit is implemented as a pair of guiding ribs 192 protruding from an upper side of the bottom surface 162 of the water collecting portion 161.

The guiding ribs 192 upwardly protrude from the bottom surface 162 of the water collecting portion 161, extend along the major axis direction of the discharge hole 164, and are disposed parallel to each other.

With such configuration, the water dropped to the water collecting portion 161 of the water funnel 190 is collected by the inclination of the bottom surface 162 and then introduced to the discharge hole 164. Here, the guiding ribs 192 serve to arrange ice pieces in the major axis direction of the discharge hole 164, whereby the ice pieces are smoothly discharged, thus to prevent the blockage of the path 172 by the ice pieces.

The foregoing embodiments have described that the discharge groove, the guiding groove and the guiding ribs are independently configured. However, two or more thereof may also be combined together.

The foregoing embodiments have configured such that the upper and lower trays are disposed inside the frame, and water is supplied to the lower tray by the water funnel. However, one tray or three or more trays may be implemented. In addition, a plurality of water funnels may be provided.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A water funnel, comprising:
a water collecting portion having a discharge hole through which water is collected and discharged; and
a drain tube having a path therein, the path downwardly extending from the water collecting portion to be communicated with the discharge hole and having a uniform cross section or a cross section increasing toward a lower side thereof.

2. The water funnel of claim 1, wherein the discharge hole is formed to have an oval shape.

3. The water funnel of claim 2, wherein the discharge hole is disposed at a bottom portion of the water collecting portion in an eccentric state to one side thereof.

4. The water funnel of claim 3, wherein the discharge hole is configured such that a major axis thereof is disposed in an eccentric direction.

5. The water funnel of claim 2, wherein the water collecting portion has a rectangular shape, and the discharge hole is configured such that a major axis thereof is disposed in a lengthwise direction of the water collecting portion.

6. The water funnel of claim 2, wherein the path of the drain tube is formed to have an oval cross section so as to correspond to that of the discharge hole.

7. The water funnel of claim 2, wherein the water collecting portion includes a guiding unit disposed along the major axis direction of the discharge hole.

8. The water funnel of claim 7, wherein the guiding unit is implemented as a guiding groove concavely formed at a bottom portion of the water collecting portion.

9. The water funnel of claim 7, wherein the guiding unit is implemented as a plurality of guiding ribs protruding from a bottom surface of the water collecting portion and disposed parallel to each other.

10. The water funnel of claim 2, wherein the water collecting portion includes a discharge groove concavely formed to be communicated with the discharge hole.

11. The water funnel of claim 3, wherein the drain tube is formed inclined toward a center of the water collecting portion.

12. The water funnel of claim 3, wherein a tapered portion having a tapered cross section is formed at the lower end of the drain tube.

13. The water funnel of claim 12, wherein the tapered portion includes a guiding protrusion protruding in a lengthwise direction.

14. An ice maker for a refrigerator, comprising:
a frame;
a tray disposed inside the frame; and
the water funnel of claim 1 disposed above the tray so as to guide ice-making water to the tray.

15. The ice maker for a refrigerator of claim 14, wherein the tray is detachably supported by the frame.

16. The ice maker for a refrigerator of claim 15, wherein the frame has an opened area at one side thereof, and further comprises a door for opening and closing the opened area of the frame.

17. The ice maker for a refrigerator of claim 15, wherein the tray is rotatably installed at the frame.

18. The ice maker for a refrigerator of claim 17, wherein the frame further comprises a lever for rotating the tray.
